(19) United States
(12) Patent Application Publication
(10) Pub. No.: US 2025/0346280 A1
(43) Pub. Date: Nov. 13, 2025

(54) HEATED STEERING WHEEL FOR REPLACING A CONVENTIONAL STEERING WHEEL ON A STEERING SHAFT OF A GOLF CART

(71) Applicant: Graig S. GUEMPEIL, Saint Louis, MO (US)

(72) Inventor: Graig S. GUEMPEIL, Saint Louis, MO (US)

(21) Appl. No.: 19/202,683

(22) Filed: May 8, 2025

Related U.S. Application Data
(60) Provisional application No. 63/644,346, filed on May 8, 2024.

(51) Int. Cl. B62D 1/06; B60R 16/027; B60R 16/033; B62D 1/04; H05B 3/22

(52) U.S. Cl. CPC B62D 1/06; B60R 16/027; B60R 16/033; B62D 1/046; H05B 3/22

(57) ABSTRACT

A heated steering wheel for replacing a conventional steering wheel on a steering shaft of a golf cart, the heated steering wheel comprising: a hub mountable on the steering shaft of the golf cart; at least one spoke extending generally radially outwardly from the hub; a generally circular wheel mounted on the distal ends of the at least one spoke; a heating element extending around the circumference of the wheel; a heating element lead extending from the heating element along one of the at least one spoke, and terminating in an electrical connector positioned closer to the hub than to the wheel; and a coiled cable having a connector on a first end for connecting with the connector on the heating element lead, and a connector on a second end for connecting to a lead extending along the steering shaft connected to a battery on the golf cart.

### FIELD

The present disclosure relates to a heated steering wheel for a golf cart.

### BACKGROUND

This section provides background information related to the present disclosure which is not necessarily prior art.

A golf cart is a small vehicle primarily designed to transport golfers and their equipment around a golf course. It typically consists of a chassis with four wheels, a seat or seats for passengers, and a platform or compartments for carrying golf bags, clubs, and other accessories. Golf carts are usually powered by electric motors or gasoline engines, allowing them to travel at low speeds suitable for use on golf courses. They provide convenience and ease of mobility for golfers during their rounds, and are typically of simple, reliable and durable construction.

### SUMMARY

This section provides a general summary of the disclosure, and is not a comprehensive disclosure of its full scope or all of its features.

Generally, this disclosure provides embodiments of a heated steering wheel for a golf cart, including one that can be retrofit to existing golf carts. The heated steering wheel comprises a hub mounted on a steering shaft of the golf cart, at least one spoke extending radially outwardly from the hub, and a circular wheel mounted on the distal ends of the at least one spoke. A heating element extends around the circumference of the wheel. A heating element lead extends from the heating element along one of the at least one spoke, and terminates in an electrical connector positioned closer to the hub than to the wheel. A coiled cable has a connector on a first end for connecting with the connector on the heating element lead, and a connector on a second end for connecting to a lead extending along the steering shaft connected to a battery on the golf cart.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom plan view of heated steering wheel in accordance with the principles of this disclosure;

FIG. 1A is an enlarged partial bottom plan view of the steering wheel shown in FIG. 1;

FIG. 2 is a schematic diagram of the circuit connecting for connecting the heated steering wheel to the battery of the golf cart;

FIG. 3 is a side elevation view of a golf cart incorporating a heated steering wheel in accordance with this disclosure;

FIG. 3A is an enlarged partial side elevation view of the golf cart incorporating a heated steering wheel shown in FIG. 4.

Corresponding reference numerals indicate corresponding parts throughout the several views of the drawings.

### DETAILED DESCRIPTION

Example embodiments will now be described more fully with reference to the accompanying drawings.

As further described herein, embodiments of this disclosure provide a heated steering wheel for replacing the conventional steering wheel on the steering shaft of a golf cart.

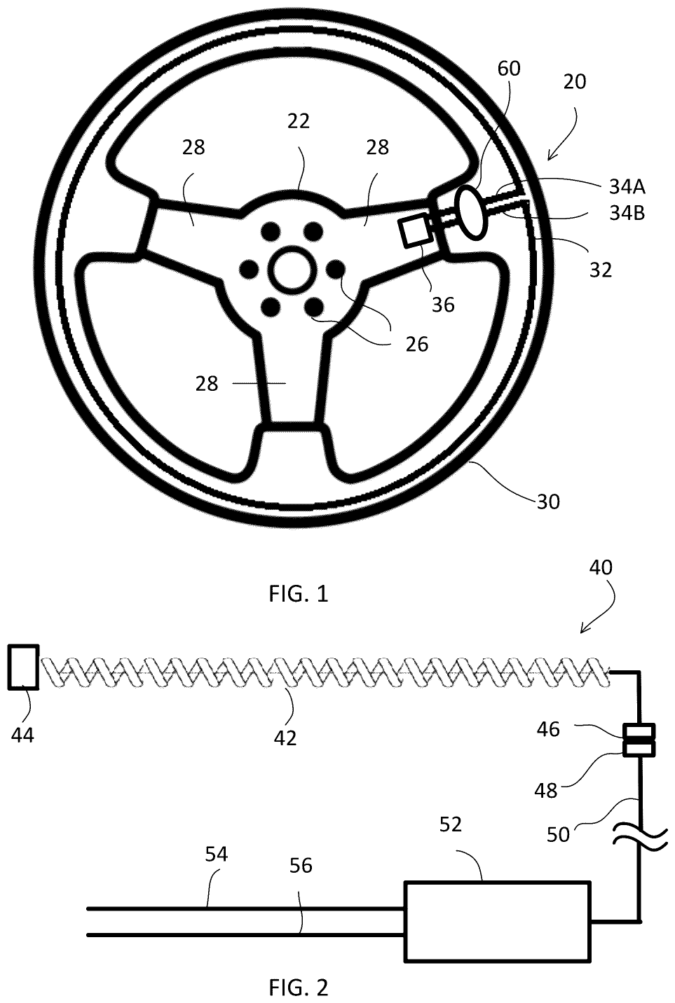

A preferred embodiment of a heated steering wheel for a golf cart according to the principles of this disclosure is indicated generally as 20 in FIG. 1. Steering wheel 20 including a hub 22 mountable on the steering shaft 24 of the golf cart. The hub 22 preferably incudes mounting holes 26 for securing the steering wheel 20 to the steering shaft 24. Six equally spaced mounting holes 26 are shown in FIG. 1, in a relatively standard configuration for the golf carts.

Steering wheel 20 further comprises at least one spoke 28 extending generally radially outwardly from the hub 22. Three spokes 28 are shown in FIG. 1. A generally circular wheel 30 is mounted on the distal ends of the at least one spoke 28.

At least one heating element is disposed on the wheel 30 of steering wheel 20. For example a heating element 32 can extend around the circumference of the wheel 30 to heat the wheel. The heating element 32 has a heating element leads 34A, 34B extending along the at least one spoke 28 and terminating in an electrical connector 36, that is preferably positioned closer to the hub 22 than to the wheel 30. As shown in FIG. 1A, the wherein the length d of the heating element leads extends at least 50% of the length D of the spoke from the wheel to the hub, more preferably at least 60%, and most preferably at least 80% of the length D. This reduces the amount of motion that the coiled cable (described below) must accommodate.

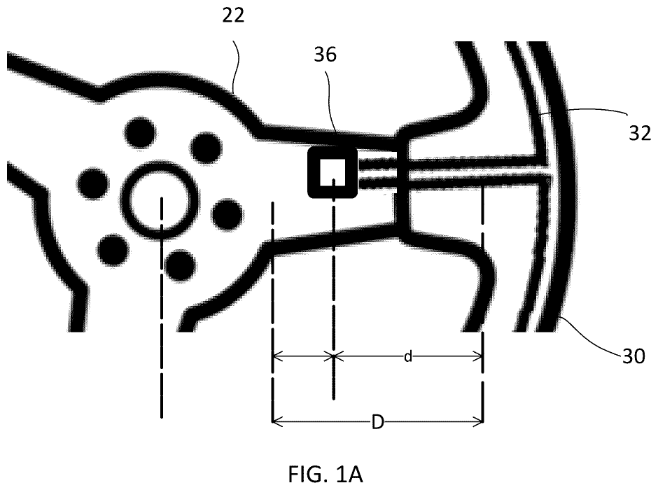

The heated steering wheel 20 can be connected to the battery of the golf cart via circuit 40, shown schematically in FIG. 2. As shown in FIG. 2 a coiled cable 42 has a connector 44 for connecting with connector 36. The coiled cable 42 can also have a connector 46 for connecting to connector 48 on cable 50. Cable 50 can extend through the golf cart to a controller 52, and battery wires 54, 56 extend from the controller 52 to a batter on the golf cart.

In some embodiments, the heated steering wheel 20 includes a switch 60 for selectively connecting and disconnecting the heating element 32 to electric power, as shown in FIG. 1. In some examples, the switch 60 is disposed on the underside of the steering wheel 20. Alternatively, the switch 60 could be disposed on one of the spokes 28, the hub 22, or elsewhere on the golf cart.

In various embodiments, the heated steering wheel 20 can include a cutoff for disconnecting the heating element 32 from electric power after a predetermined time. This cutoff can be incorporated into the switch 60, or it can be incorporated into controller 53. The predetermined time may be set upon manufacture, or it can be set by the user.

In other embodiments, a cutoff may automatically disconnect the heating element 32 from electric power when the golf cart battery reaches a predetermined level of remaining charge. This cutoff can be implemented in controller 52. The predetermined level may be set upon manufacature, or it can be set by the user.

In some embodiments, the heated steering wheel 20 includes a thermostatic regulator for regulating the power supplied to the heating element to maintain the temperature of the steering wheel 20 in a preselected range. The thermostatic regulator may regulate the power by any means that allow for the temperature of the steering wheel remain within a preselected range by the driver. For example, the power may be regulated with a resistor, a capacitor, a voltage regulator, etc. The thermostatic regulator can be incorporated into the steering wheel 20 and/or the switch 60.

In other embodiments, the heated steering wheel 20 may include a thermostatic control. The thermostatic control may automatically connect the heating element to electric power when the ambient temperature is below a predetermined threshold. The predetermined threshold may be set upon manufacture, or by the user. The thermostatic control may be incorporated into control 52, using an on board or a remote temperature sensor.

In other embodiments, the thermostatic control may automatically disconnect the heating element from electric power when the ambient temperature is above a predetermined threshold. The predetermined threshold may be set upon manufacture, or by the user.

In other embodiments, the control 52 may be used to automatically disconnect the heating element from electric power when the golf cart has been idle for a predetermined threshold of time. The control 52 can determine when the golf cart is idle by measuring batter usage, or including a motion sensor. The control 52 may be used to keep the battery power level higher by turning off the heating element to save battery power.

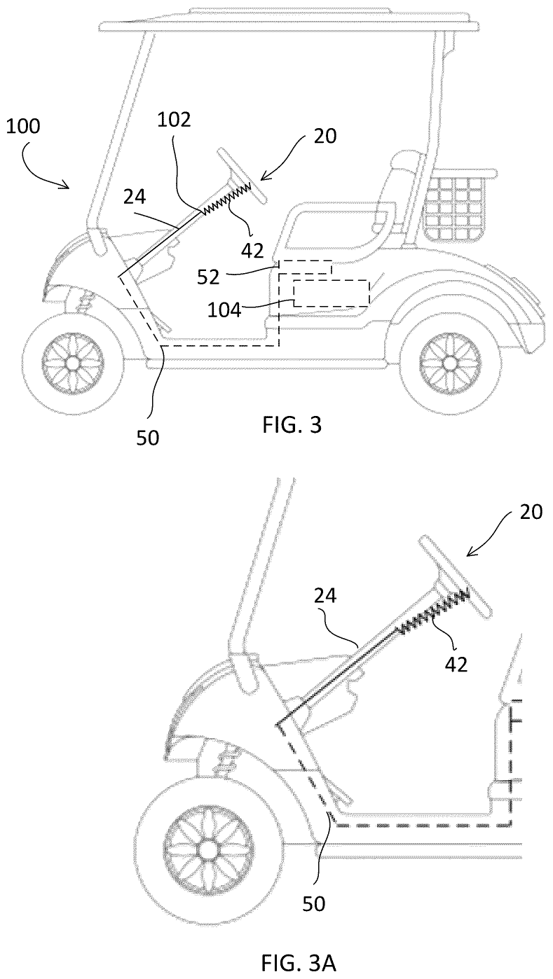

As shown in FIGS. 3 and 3A, a golf cart 100 is provided with a heated steering wheel 20. The heating element 32 of the heated steering wheel 20 is connected to a coiled cable 42. The coiled cable 42 is connected to cable 50, via connectors 46/48, and preferably secure to the steering shaft 24 and 102. The coiled cable can expand to accommodate rotation of the steering wheel, wrapping around the steering shaft. When the steering wheel 20 returns to its neutral position, the coil returns to its taut, unstretched condition. The length of the coiled cable 42 is selected to accommodate the anticipated motion of the steering wheel.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heated steering wheel for replacing a conventional steering wheel on a steering shaft of a golf cart, the heated steering wheel comprising:
a hub mountable on the steering shaft of the golf cart;
at least one spoke extending generally radially outwardly from the hub;
a generally circular wheel mounted on the distal ends of the at least one spoke;
a heating element extending around the circumference of the wheel;
a heating element lead extending from the heating element along one of the at least one spoke, and terminating in an electrical connector positioned closer to the hub than to the wheel; and
a coiled cable having a connector on a first end for connecting with the connector on the heating element lead, and a connector on a second end for connecting to a lead extending along the steering shaft connected to a battery on the golf cart.

2. The heated steering wheel of claim 1, wherein the heating element lead extends at least 80% of the length of the spoke from the wheel to the hub.

3. The heated steering wheel according to claim 1 further comprising a switch for selectively connecting the heating element to electric power.

4. The heated steering wheel according to claim 1 wherein a switch is disposed on the generally circular wheel.

5. The heated steering wheel according to claim 1 wherein a switch is disposed on the hub.

6. The heated steering wheel according to claim 1 wherein a switch is disposed on one of the at least one spokes.

7. The heated steering wheel according to claim 1 further comprising a cutoff for automatically disconnecting the heating element from electric power after a predetermined time.

8. The heated steering wheel according to claim 1 further comprising a thermostatic regulator regulating the power supplied to heating element to maintain the temperature of the steering wheel in a preselected range.

9. The heated steering wheel according to claim 1 further comprising a cutoff for automatically disconnecting the heating element from electric power when the battery reaches a predetermined level of remaining charge.

10. The heated steering wheel according to claim 1 further comprising a thermostatic control for automatically connecting the heating element to electric power when the ambient temperature is below a predetermined threshold.

11. The heated steering wheel according to claim 1 further comprising a thermostatic control for automatically disconnecting the heating element from electric power when the ambient temperature is above a predetermined threshold.

12. The heated steering wheel according to claim 1 further comprising a control for automatically disconnecting the heating element from electric power when the golf cart has been idle for a predetermined threshold of time.

13. An improved golf cart of the type having a steering wheel, wherein the improvement comprises an electric heating element integrated into the steering wheel to heat the surface of the steering wheel.

14. The improved golf cart according to claim 13 further comprising a switch for selectively connecting the heating element to electric power.

15. The improved golf cart according to claim 13 wherein a switch is disposed on the generally circular steering wheel.

16. The improved golf cart according to claim 13 further comprising a cutoff for automatically disconnecting the heating element from electric power after a predetermined time.

17. The improved golf cart according to claim 13 further comprising a thermostatic regulator regulating the power supplied to the heating element to maintain the temperature of the steering wheel in a preselected range.

18. The improved golf cart according to claim 13 further comprising a cutoff for automatically disconnecting the heating element from electric power when the golf cart battery reaches a predetermined level of remaining charge.

19. The improved golf cart according to claim 13 further comprising a thermostatic control for automatically connecting the heating element to electric power when the ambient temperature is below a predetermined threshold.

20. The improved golf cart according to claim 13 further comprising a thermostatic control for automatically disconnecting the heating element from electric power when the ambient temperature is above predetermined threshold.

21. The improved golf cart according to claim 13 further comprising a control for automatically disconnecting the heating element from electric power when golf cart has been idle for a predetermined threshold of time.
